(19) United States
(12) Patent Application Publication
(10) Pub. No.: US 2016/0087485 A1
(43) Pub. Date: Mar. 24, 2016

(54) IN-VEHICLE WIRELESS CHARGING SYSTEM

(71) Applicant: Lear Corporation, Southfield, MI (US)

(72) Inventors: Hiroyuki MAEDA, Canton, MI (US); Riad GHABRA, Northville, MI (US); Gerard Leonard GRABOWSKI, Brownstown, MI (US); Frank BUCCINNA, Livonia, MI (US); Anthony MANSOUR, Clawson, MI (US)

(21) Appl. No.: 14/864,173

(22) Filed: Sep. 24, 2015

Related U.S. Application Data
(60) Provisional application No. 62/054,714, filed on Sep. 24, 2014.

(51) Int. Cl. H02J 7/02; H02J 7/00; H04W 76/02

(52) U.S. Cl. CPC H02J 7/025; H04W 76/02; H02J 7/0044

(57) ABSTRACT

A vehicle component for charging a mobile device is described. The vehicle component can be placed in the door or a seat, away from the dashboard. The vehicle component can include a holder configured to hold a mobile device and charging circuitry, adjacent the holder, to wirelessly, electrically communicate with the mobile device to determine a charging protocol of the mobile device and to wirelessly transmit a charging signal to the mobile device. The circuitry of the vehicle or the holder can determine the charging protocol for the mobile device and engage that protocol to wirelessly charge the mobile device.

### CROSS-REFERENCE TO RELATED APPLICATIONS

This application claims the benefit of U.S. Provisional application Ser. No. 62/054,714, Sep. 24, 2014 the disclosure of which is incorporated in its entirety by reference herein.

### TECHNICAL FIELD

The following relates to a system and a method for wireless charging of electronic devices in a vehicle.

### BACKGROUND

Automotive vehicles often include electrically powered systems that connect electronic devices via wired connections. Vehicles can also include connections to electronic devices in the dashboard or console. However, there is a lack of adequate structures for wirelessly charging mobile electronic devices.

### BRIEF DESCRIPTION OF THE DRAWINGS

FIG. 1 shows a view of a wireless charging structure in a vehicle according to embodiments of the present disclosure.

FIG. 2 shows a vehicle door having a wireless charging structure according to embodiments of the present disclosure.

FIG. 3 shows a schematic view of a wireless charging structure in a vehicle according to embodiments of the present disclosure.

FIG. 4 shows a view of a vehicle interior according to embodiments of the present disclosure.

FIG. 5 shows a view of a vehicle seat according to embodiments of the present disclosure.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as representative basis for teaching one skilled in the art to variously employ the present invention.

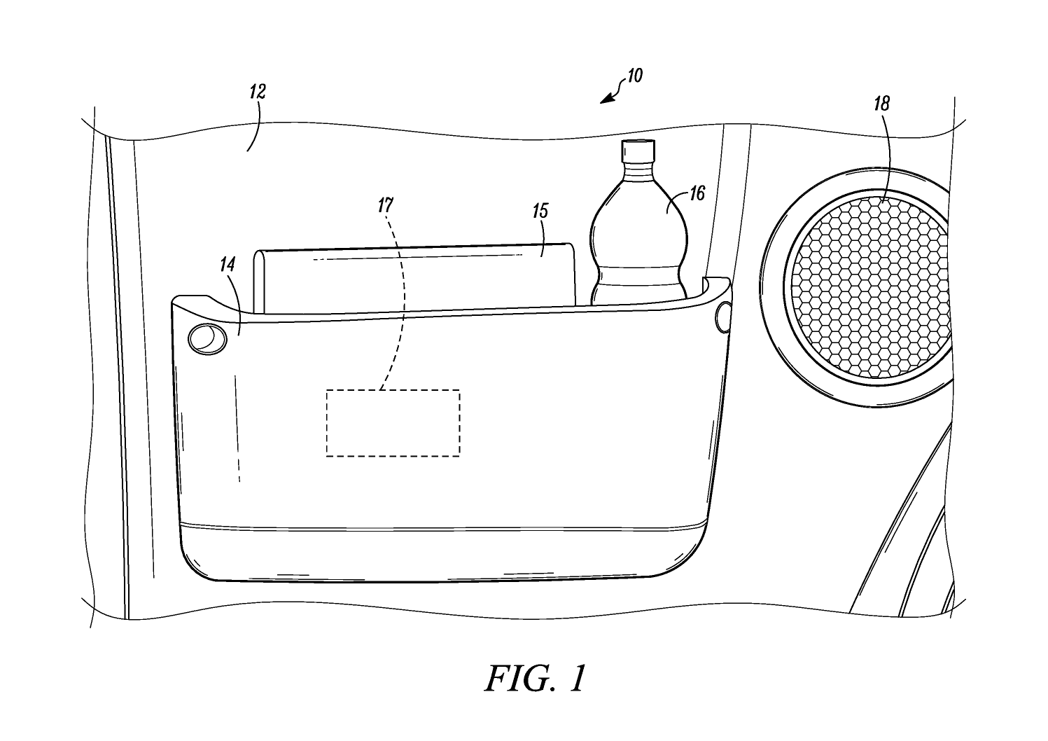

Referring now to FIG. 1, a vehicular environment is shown for an embodiment of a vehicle mounted wireless charging system 10. The vehicular environment can be a seat or a door 12. The door 12 can include a mobile device holder 14 that is configured to removably hold a mobile device 15. The mobile device 15 can be an electronic device that has a battery, which stores electrical charge that is used to power the mobile device 15 and at times needs to be recharged with electrical energy. Examples of mobile devices include, but are not limited to, phone, smart phone, tablet, computing device, phablet, laptop, netbook, computer or the like. A mobile device 15 is removable from the vehicle and the holder 14 as needed by the user. The holder 14 can include circuitry 17 to send charging signals to the mobile device and to receive control signals or charging power signals from the vehicle circuitry. The holder 14 can be fixed to the door 12 using fasteners or integrally formed with a panel of the door 12. The holder 14 forms a space or interstice that receives the mobile device and aligns the mobile device with a transmitter (which can be part of circuitry 17) that sends a power signal to the mobile device 15. The holder 14 can enclose the interstice on four sides with the door forming one side with an open top to receive the mobile device. The holder 14 can include mechanism(s) to align the mobile device 15 in the holder 14 such that the mobile device 15 is secured in the holder and aligned with the wireless communication circuitry of the door or holder. The door 12 or holder 14 can further include other circuitry for wireless communication, e.g., Bluetooth, IEEE 802 standards, near field communication, with the mobile device 15.

The holder 14 can also secure other structures 16. Other vehicle environment devices 18 can be mounted to or in the door 12. Devices 18 can include audio speakers, window controls, mirror positioning controls, door locks, door handles, audio controls, heating and cooling controls etc., which can each include mechanical switches, electro-mechanical switches, electrical switches, wiring, and/or wireless connections. The door mounted controls and electrical communications are less affected by stray electrical interference than some circuits, e.g., a radio or other wireless electrical receiver, which are mounted in the dashboard assembly of the vehicle.

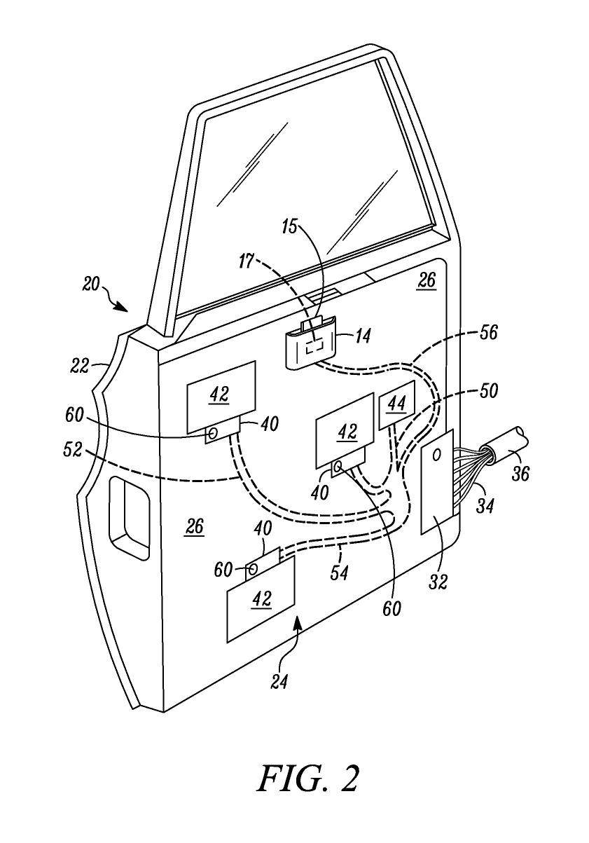

FIG. 2 shows a vehicle door structure 20. The holder 14 is mounted adjacent the upper part of the door assembly below the window. The holder 14 can position the mobile device at a position that can be viewed by the vehicle driver, if a driver side door, or viewed by a passenger, if a passenger or rear door. The vehicle door structure 20 includes a door frame 22 that is illustrated schematically. The door structure 20 can include a plurality of layers are supported on the door frame 22 in a conventional manner. The layers can include a first non-conductive layer 26 and a second non-conductive layer 28. The non-conductive layers can be conventional vapor barriers, finish layers or noise barriers, or combinations thereof, respectively. A wiring layer 30 is disposed in the layers 26 and 28 an can include a generally continuous sheet of conductive material or individual wires. In an embodiment, a generally flat sheet of metal is used as the sheet of conductive material. In another example, the conductive layer 30 can include a conductive wire mesh material. The conductive layer 30 includes an input terminal 32. A plurality of wires 34 that are supported in a wire harness 36 protrude into the door frame 22 and are coupled with the conductive layer 30 through the input terminal 32. The wires 34 provide the electrical power to the various loads supported on the door frame 22, including the circuitry 17 in or associated with the holder 14 for interaction with the mobile device 15. The term electrical power is used in this specification generically to include power per se and electrical signals that are useful to control the operation of a load. A plurality of connectors 40 are coupled to the conductive layer 30. The connectors 40 provide a connection between the conductive layer 30 and a plurality of loads 42, including the circuitry associated with the holder 14. Example loads include power door locks, a window lift motor, mirror position control and the mobile device holder 14. A return ground path is provided, for example, by a connection between the loads 42 and the door frame 22 or through wired connections back through the input terminal 32. In an example, the transfer of electrical signals or data among the various loads 42 preferably is accomplished by wires in the conductive layer 30. In an example, at least some of the transfer of electrical signals or data among the various loads 42 can be accomplished by a wireless multiplexing system schematically shown at 44. In an example, infrared technology is utilized. Alternatively, radio frequency signals can be used. Since multiplexing technology can be employed, the loads 42, including the circuitry associated with holder 14, or the connectors 40 can be multiplexed transceivers that are adapted to handle the signals. Since a variety of loads 42 and a variety signals will likely be employed, signal guides or channels preferably are provided in a plastic molded portion of the door to enhance signal communication and to ensure that signals are not obstructed. In an example, the non-conductive layer 26 includes signal guide passages 50, 52, 54 and 56 (illustrated in phantom). In another example, the guide passages 50, 52, 54 and 56 represent wired connections that can transmit electrical signals. Each connector 40 can include a penetrating member 60 that penetrates through the conductive layer 30. In the embodiment of FIG. 1, the penetrating members 60 penetrate through the non-conductive layers and the conductive layer 30.

Given this description, those skilled in the art will be able to choose from among appropriate conductive materials to realize the conductive layer 30. Similarly, given this description, those skilled in the art will be able to choose from among commercially available multiplexing components or develop appropriate software to realize the communication of power along the conductive layer 30 and control signals to the various loads 42.

The holder 14 is further sized to hold a many different sized mobile devices 15, e.g., from a small phone or audio player to a tablet computer. In an example, the holder can hold a mobile device that can have up to a 20.0 mm in depth, 12 inches tall and 7.5 inches in width but be able to removably hold mobile devices that have dimensions less than these dimensions. In an example, the holder 14 can center the electronic device 15 aligned with the charging circuitry 17.

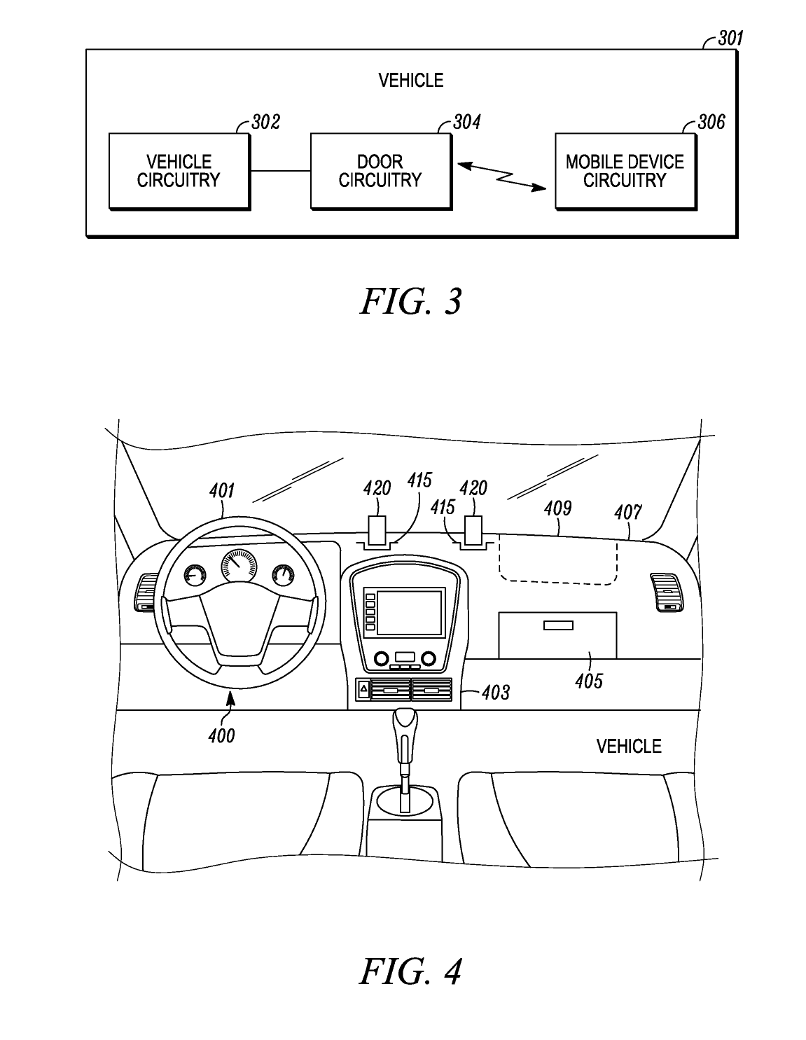

FIG. 3 shows a schematic view wireless charging structure in a vehicle 301. Vehicle circuitry 302 is provided in the vehicle 301 and can be mounted within the cabin or in the engine compartment. Door circuitry 304 is electrically connected to the vehicle circuitry and is mounted in the door. The door circuitry may include the charging circuitry 17 as shown in FIGS. 1 and 2. The door circuitry 304 can also be in communication with the mobile device circuitry 306, e.g., when the mobile device is in the vehicle, in the mobile device holder, or within wireless communication range of the vehicle and mobile device using a communication protocol. Vehicle circuitry 302 can include at least one processor and at least one memory device. The vehicle circuitry can be used to control vehicle operations, including, but not limited to, engine performance, electrical motive components, information systems, entertainment systems and cabin controls. The vehicle circuitry 302 can also provide electrical power signals to the door circuitry 304 to wirelessly charge the mobile device through its own circuitry 306. Vehicle circuitry 302 can provide instructions that when loaded into a processor (at which time the processor is dedicated to the instructions) can be used to determine the type of charging protocol that will be used to charge the battery of the mobile device. In an example, the vehicle circuitry can store the type of protocol to be used to charge any mobile device that is paired with the vehicle. When the vehicle circuitry 302 senses the presence of the paired mobile device the vehicle circuitry retrieves the charging protocol from memory and loads the protocol to a processor or to the door circuitry 304 to control the charging power signal being wirelessly applied to the mobile device stored in the holder.

If the vehicle does not know the mobile device positioned in the holder (e.g., mobile device is not paired to vehicle), then the vehicle circuitry 302 can cycle through the charging protocols by instructing the door circuitry 304 to send test signals to the mobile device circuitry 306 to determine the type of wireless charging, if any. The door circuitry 304 can send a short duration test charging signal to the mobile device and sense the interaction of the mobile device with the signal, e.g., drop in sent signal strength when the mobile device circuitry begins drawing power from the sent test signal.

In another example, a query signal can be sent from the door circuitry or the vehicle circuitry to the mobile device. The mobile device can send a return signal identifying the type of charging protocol it uses to charge its battery wirelessly. That is, the vehicle can identify a wirelessly chargeable mobile device at the charger. The circuitry may also detect the presence of a foreign object at the charger or circuitry. If a foreign object is detected, then the circuitry does not apply a charging signal to the charging circuitry. In an example, the default state is to not apply a charging signal. In an example, only when a mobile device is detected and a charging standard is selected for that particular device does the circuitry apply a charging signal to charge the mobile device. When an object is at the charger but the vehicle does not recognize the device and cannot charge the device, then the vehicle circuitry may inform the user, e.g., driver or vehicle occupant, that a non-chargeable object is positioned at the charger. Detection of non-mobile devices, non-chargeable objects, or foreign objects at the charger may reduce the possibility of energizing an unwanted object.

In an example, the mobile device may use at least one of Qi, Powermat, or A4WP protocols for wireless charging. As these wireless protocols use various frequencies for charging, it is important for the vehicle to provide the correct charging signal to the mobile device for any charging to occur. In an example, the charging signal from the vehicle is in the range of 100-205 kHz or 277-357 kHz. The present circuitry can detect the operation frequency range and use the result to determine the type of charging protocol being used. Another example of a charging signal is a magnetic resonance signal, which is different than a magnetic induction charging signal. The magnetic resonance signal may be used in a vehicle environment as the charging signal may have to pass through layers, vehicle interior fabric, vehicle interior plastics, articles in the vehicles placed there by users. Moreover, magnetic resonance may also be superior when used in the presence of other metallic objects.

In an example, the door circuitry 304 can have a single primary antenna for sending the charging signal to the mobile device. At least one of the door circuitry 304 or the vehicle 302 controls the signal provided to the antenna for emission to the mobile device in the holder.

FIG. 4 shows a view of a dashboard assembly 400 for a vehicle. The dashboard assembly 400 can include a steering wheel 401, a center console 403, a glove box 405 and a dashboard 407. The center console 403 can include a video screen and house a radio and user interaction locations, e.g., buttons, switches, touch screens, sliders, etc. An airbag 409 can be mounted in the dashboard. At least one holder 415 can be positioned in the dashboard 407. The holder 415 can include the wireless charging structures described herein for wirelessly charging a mobile device 420 positioned in the holder 415. As illustrated there are two holders 415 to hold a mobile device for the driver and one for a passenger.

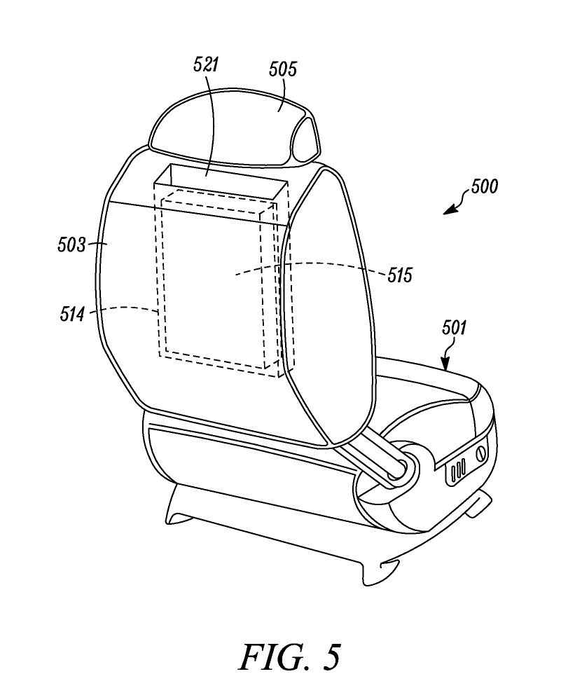

FIG. 5 shows a view of a vehicle seat 500 that includes a seat 501 on which a user can sit in a cabin of a vehicle and a seat back 503 connected to the seat 501 and configured to support a user's back. A head rest 505 can be at the top of the seat back 503. A mobile device holder 514 is positioned in the seat back 503 and is configured to receive a mobile device 515. The mobile device holder 514 can have any of the features of a holder as described herein, including wireless charging of the mobile device. As shown, the holder 514 has an open top 521 and closed on all other sides. In an example, the outer portion of the holder can have a cutout or a clear cover so that a user can see the device 515 when stored in the holder 514.

The vehicle can have a wireless vehicle entry system, e.g., the system described in U.S. Patent Application Publication No. 2008/0174446, titled “Multi-Channel Passive Vehicle Activation System” and U.S. Pat. Nos. 7,388,466, titled “Integrated Passive Entry and Remote Keyless Entry System” and 8,531,268, titled “Passive Entry System for an Automotive Vehicle,” which are hereby incorporated by reference. The wireless system(s) described herein for charging or communicating with the mobile device in the holder can be turned off when the wireless vehicle entry system is in use. In an example, the token described in U.S. Pat. No. 8,531,268 can be incorporated into the mobile device. This can be used with any of the examples of the holder and wireless charging as described herein. The positioning of the holder e.g., 14 or 514 (FIGS. 1-3), can be such that the operation of the holder does not interfere with these passive or electronic vehicle entry systems. For the different wireless charging standards (e.g., Qi, A4WP, and PowerMat), the wireless charger may pause the currently active wireless charging session during a wireless entry system (e.g., PEPS) transmission depending on whether the currently active wireless charging protocol will interfere with the wireless entry system frequencies.

Like these entry systems, the wireless mobile device charging system can be fully integrated into the vehicle electrical distribution system. At various times during operation of the vehicle, it may be desirable to automatically turn off the wireless charging system. For example, during operation of a wireless vehicle entry system, the charging system can be turned off to reduce the likelihood of interference with operation of a wireless vehicle entry system. In an example, the vehicle circuitry prevents a power signal to the charger when it may interfere with other vehicle operations. The vehicle circuitry may pause or turn off the wireless charger when the vehicle is in a an engine start mode, e.g., the vehicle circuitry is cranking the motor for a motor start and is directing most, if not all, electric power to the starter. The vehicle circuitry may further pause or turn off the wireless charger, even when mobile device charging is desired, based on electrical energy management strategies of the vehicle. For example, an electric or hybrid vehicle monitors various states of its electrical draw and storage on its low voltage side and if the electrical power on the low voltage side is low or passes a threshold, then the vehicle circuitry can turn off the wireless charging. In an internal combustion vehicle, the vehicle can also monitor its electrical draw, in either a vehicle on or off state, and turn off the wireless charging if the electrical draw of the wireless charger will cause the electrical state to pass a threshold. The wireless charger may pause the currently active wireless charging session according to the energy management strategy implemented in the vehicle electrical distribution system. In some examples, the wireless charger can have similar controls as a vehicle convenience feature. In an example, the pause of the wireless charger does not reset the charging cycle. This can be done so that the vehicle can be started, e.g., the starter cranks the engine, with all battery power or with no battery power to the charging circuitry. The charging circuitry is instructed by the vehicle circuitry to hold its place in the charging cycle while power in interrupted to the charging circuitry. When the power resumes, after the motor starts, the charging circuitry continues from its stored point where power was interrupted. In a hybrid vehicle and an environmentally-concerned vehicle examples, the vehicle may turn off when stopped and restarted when the driver desires the vehicle to move. When the vehicle motor is restarted, the charger may pause while the motor restarts.

The presently described examples described herein for various embodiments can offer innovative features relating a wireless charging of electronic devices in a vehicle. By moving the location of a mobile device holder from the typical dashboard location, the embodiments described herein can provide easy access to the mobile device for a user, a safer location in case of accidents, proper functionality for charging, positioning the mobile device away from sensitive electronics (e.g., the radio or other transmitter receivers) thus reducing electro-magnetic interference issues and helping tin insure electro-magnetic compatibility, and providing a dedicated location away from the busy center console of the vehicle.

Aspects of the invention may include the following.

A method for in-vehicle charging a mobile electronic device comprising: holding a mobile device in a vehicle cabin; determining the charging protocol for the mobile device; and charging the mobile device using the determined charging protocol.

In an example, holding the mobile device includes removably securing the mobile device in a door pocket or a seat pocket. These locations are remote from the center console of the vehicle.

In an example, determining the charging protocol includes cycling through charging protocols or frequencies to determine the charging abilities of the mobile device. The vehicle can sense the type of charging for the mobile phone. The vehicle can store the type of charging for the mobile device in its memory. When a mobile device is next placed in a holder in the vehicle, the testing of the charging type for that mobile device starts with the previously determined charging type. Some wireless charging protocols can include Qi, PowerMat, Rezence. The holder circuitry can also use dual mode Bluetooth communication with the mobile device.

In an example, when the mobile device is removed from the holder, the charging signal from the vehicle to the mobile device is stopped.

In an example, the mobile device is paired for electrical communication with the vehicle, e.g., using Bluetooth communication protocol or using near field communication.

In an example, the mobile device is positioned, for viewing by a vehicle passenger, adjacent the holder.

In an example, the mobile device can be placed in the holder, e.g., by a user, driver, or passenger. The holder circuitry can be adjacent the holder and configured to sense the presence and capabilities of the mobile device. If the mobile device supports pairing, then the mobile device is paired with the vehicle. The mobile device may have NFC pairing. The mobile device may also include a code that can be read by a reader in the holder that can be read to determine the capability of the mobile device.

In an example, the holder determines that a mobile device is present and then sends a signal to vehicle infotainment system to initiate pairing of the mobile device to the vehicle, e.g., through circuitry on the vehicle and circuitry on the mobile device.

In an example, the holder circuitry can determine the charging level of the mobile device and communicate same to the infotainment system, which can then put this information on a vehicle display to communicate the information to the user.

A vehicle component for charging a mobile device may include a door having a holder configured to hold a mobile device; charging circuitry, adjacent the holder, to wirelessly, electrically communicate with the mobile device to determine a charging protocol of the mobile device and to wirelessly transmit a charging signal to the mobile device.

The vehicle component for use with an example herein, wherein the charging circuitry includes a primary coil in the door.

The vehicle component for use with an example herein, wherein the charging circuitry includes a primary coil in the holder.

The vehicle component for use with an example herein, wherein the holder includes a pouch that extends inwardly from a surface of the door to create an interstice to receive the mobile device and a mechanism to secure the mobile device such that the mobile device can be at least partially viewed by a vehicle driver.

The vehicle component for use with an example herein, wherein the circuitry includes a processor to send an interrogation signal to the mobile device and receive a response signal from the mobile device to identify the charging protocol of the mobile device.

The vehicle component for use with an example herein, wherein the circuitry cycles through charging protocols until it determines the charging protocol for the mobile device.

A vehicle component for charging a mobile device may include a seat having a holder configured to hold a mobile device; charging circuitry, adjacent the holder, to wirelessly, electrically communicate with the mobile device to determine a charging protocol of the mobile device and to wirelessly transmit a charging signal to the mobile device.

The vehicle component for use with an example herein, wherein the charging circuitry includes a primary coil in the seat.

The vehicle component for use with an example herein, wherein the charging circuitry includes a primary coil in the holder.

The vehicle component for use with an example herein, wherein the holder includes a pouch that extends inwardly from a surface of the seat to create an interstice to receive the mobile device and a mechanism to secure the mobile device such that the mobile device can be at least partially viewed by a vehicle passenger.

The vehicle component for use with an example herein, wherein the circuitry includes a processor to send an interrogation signal to the mobile device through circuitry in the seat and receive a response signal from the mobile device to identify the charging protocol of the mobile device.

The vehicle component for use with an example herein, wherein the circuitry cycles through charging protocols until it determines the charging protocol for the mobile device.

The vehicle component of any preceding statement, further comprising a near field communication circuitry adjacent the holder and positioned to communicate with the mobile device and not interfere with charging the mobile device.

The vehicle component of any preceding statement, wherein the circuitry pairs the mobile device to vehicle circuitry using the near field communication if the mobile device is equipped with near field communication and absent near field communication the circuitry pairs the mobile device to the vehicle circuitry using Bluetooth communication.

The vehicle component of any preceding statement, wherein the mobile device is one of a phone, smart phone, tablet, computing device, phablet, laptop, netbook, computer or the like.

The vehicle component of any preceding statement, wherein the circuitry includes a single antenna to wirelessly transmit the charging signal to the mobile device.

The vehicle component of any preceding statement, wherein the circuitry does not transmit a charging signal when vehicle is receiving a passive entry system signal.

The vehicle component of any preceding statement, wherein the circuitry receives a passive entry signal from the mobile device that can be used to determine the charging signal to be applied to the mobile device when removably mounted in the holder.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

The invention claimed is:

1. A method for in-vehicle charging a mobile electronic device comprising:
holding a mobile device in a door or a seat pocket in a vehicle cabin;
determining the charging protocol for the mobile device; and
charging the mobile device using the determined charging protocol.

2. The method of claim 1, wherein holding the mobile device includes removably securing the mobile device in the door pocket or the seat pocket remote from the center console of the vehicle.

3. The method of claim 1, wherein determining the charging protocol includes cycling through charging protocols or frequencies to determine the charging abilities of the mobile device so that the vehicle can wirelessly sense the type of charging for the mobile phone from a plurality of charging protocols stored in the vehicle.

4. The method of claim 1, wherein when the mobile device is removed from the holder, the charging signal from the vehicle to the mobile device is stopped.

5. The method of claim 1, further comprising pairing the mobile device for electrical communication with the vehicle.

6. The method of claim 1, wherein holding a mobile device in a vehicle cabin includes positioning the mobile device for viewing by a vehicle passenger with the holder circuitry being adjacent the holder and configured to sense the presence and capabilities of the mobile device to pair the mobile device to vehicle circuitry using a code from the mobile device transmitted to the vehicle circuitry.

7. The method of claim 1, wherein the holding includes determining that a mobile device is present and then sending a signal to vehicle infotainment system to initiate pairing of the mobile device to the vehicle.

8. The method of claim 1, wherein charging includes determining a charging level of the mobile device and communicating the determined charging level to a vehicle infotainment system, and further comprising displaying the charging level on a vehicle display.

9. A vehicle component for charging a mobile device, comprising:
a door having a holder configured to hold a mobile device;
charging circuitry, adjacent the holder, to wirelessly, electrically communicate with the mobile device to determine a charging protocol of the mobile device and to wirelessly transmit a charging signal to the mobile device.

10. The vehicle component of claim 9, wherein the charging circuitry includes a primary coil in the door.

11. The vehicle component of claim 9, wherein the charging circuitry includes a primary coil in the holder.

12. The vehicle component of 12, wherein the holder includes a pouch that extends inwardly from a surface of the door to create an interstice to receive the mobile device and a mechanism to secure the mobile device such that the mobile device can be at least partially viewed by a vehicle driver.

13. The vehicle component of claim 9, wherein the circuitry includes a processor to send an interrogation signal to the mobile device and receive a response signal from the mobile device to identify the charging protocol of the mobile device.

14. The vehicle component of claim 9, wherein the circuitry cycles through charging protocols until it determines the charging protocol for the mobile device.

15. A vehicle component for charging a mobile device, comprising:
a seat having a holder configured to hold a mobile device;
charging circuitry, adjacent the holder, to wirelessly, electrically communicate with the mobile device to determine a charging protocol of the mobile device and to wirelessly transmit a charging signal to the mobile device.

16. The vehicle component of claim 15, wherein the charging circuitry includes a primary coil in the seat.

17. The vehicle component of claim 15, wherein the charging circuitry includes a primary coil in the holder.

18. The vehicle component of claim 17, wherein the holder includes a pouch that extends inwardly from a surface of the seat to create an interstice to receive the mobile device and a mechanism to secure the mobile device such that the mobile device can be at least partially viewed by a vehicle passenger.

19. The vehicle component of claim 15, wherein the circuitry includes a processor to send an interrogation signal to the mobile device through circuitry in the seat and receive a response signal from the mobile device to identify the charging protocol of the mobile device.

20. The vehicle component of claim 15,
wherein the circuitry cycles through charging protocols until the charging protocol for the mobile device is determined,
further comprising a near field communication circuitry adjacent the holder and positioned to communicate with the mobile device and not interfere with charging the mobile device,
wherein the circuitry pairs the mobile device to vehicle circuitry using the near field communication if the mobile device is equipped with near field communication and absent near field communication the circuitry pairs the mobile device to the vehicle circuitry using Bluetooth communication,
wherein the circuitry includes a single antenna to wirelessly transmit the charging signal to the mobile device,
wherein the circuitry does not transmit a charging signal when vehicle is receiving a passive entry system signal, and
wherein the circuitry receives a passive entry signal from the mobile device that can be used to determine the charging signal to be applied to the mobile device when removably mounted in the holder.
